(19) United States
(12) Patent Application Publication
(10) Pub. No.: US 2005/0162765 A1
(43) Pub. Date: Jul. 28, 2005

(54) Micromirror with rib reinforcement

(76) Inventors: Paul Merritt Hagelin, Saratoga, CA (US); Pavan Omkarnath Gupta, Belmont, CA (US); Gregory Andronaco, Palo Alto, CA (US)

Correspondence Address: SAWYER LAW GROUP LLP, P.O. Box 51418, Palo Alto, CA, 94303, US

(21) Appl. No.: 10/764,018

(22) Filed: Jan. 22, 2004

(51) Int. Cl. G02B 7/182

(52) U.S. Cl. 359/872; 359/224

(57) ABSTRACT

The invention provides a micromirror for directing a beam of light. The micromirror includes a mirror plate movably coupled to a substrate and a lower reinforcement rib connected to a lower surface of the mirror plate. The lower reinforcement rib is formed in a rib trench within the substrate when at least a portion of the mirror plate is formed. The lower reinforcement rib reinforces the mirror plate to minimize mirror plate curvature. A system for directing a beam of light and a method of fabricating a reinforced micromirror is also disclosed.

### FIELD OF THE INVENTION

The present invention relates generally to optical switches and scanners, and more specifically to reinforcement structures for thin-film MEMS mirrors.

### BACKGROUND OF THE INVENTION

A flat micromirror is essential for directing a beam of light with micro-electro-mechanical system (MEMS) devices used for optical cross-connect switches, optical scanners, projection and display devices, fiber optic switches, sensors, data-storage and other beam-steering devices. The silicon membrane or backing plate of the movable mirror may exhibit undesirable curvature due to internal film stresses or when its surface is metallized with a reflective metal or otherwise coated with a reflector. Optical systems may include arrays of these MEMS devices, each device having a micromirror that is individually controllable to reflect light in different directions.

An exemplary several-micron thick micromirror includes a freestanding single-crystal, silicon, thin-film polycrystalline silicon, or deposited silicon nitride structure having a reflective metal film deposited on its movable-membrane substrate. These reflective metal films of gold, silver, rhodium, platinum, copper or aluminum typically have a thickness ranging from about 20 nm to about 2000 nm. A deposited bonding layer between the metal film and the membrane may be used to improve adhesion.

The deposition of reflectors such as mirror metals can cause stresses in the membrane, leading to undesirable mirror curvature that causes a non-focused or skewed light reflection and variable or increased loss of optical signal. Internal stresses within the mirror membrane material can also cause curvature. For example, when the film or layer is more tensile on top than on the bottom, the micromirror tends to curl upward.

Mirror curvature is also due in part to the coefficient of thermal expansion (CTE) mismatch conditions of the reflector, adhesion layer, and membrane materials. Optical MEMS mirrors are often subjected to high temperature exposure for the purpose of assembly, packaging and other manufacturing processes and during operation. During operation, mirrors may curve with changes in operating temperature.

Other materials with a closer CTE match to the mirror membrane, such as dielectric layers, may be used to create the reflector. However, intrinsic, as-deposited stress in dielectric reflectors can also lead to undesired mirror curvature.

When movable MEMS micromirrors comprise thick single-crystal silicon, the mirrors may be flat and relatively stable over temperature, but the additional mirror mass can cause ringing. In addition, the mass and inertia of the mirror affect negatively the dynamics of mirror movement, slowing down the response time substantially and requiring greater actuation voltage to control the mirror.

When a thinner single-crystal silicon layer is used to fabricate a micromirror, the mirror may be flat and lightweight without a reflector, but it is not robust to intrinsic stress in the reflector layer and does not remain uniformly flat over temperature. Unless the temperature of a mirror is tightly controlled, the mirror deforms due to the mismatched coefficients of thermal expansion (CTE) of the single-crystal silicon and the reflector. A requirement to control mirror temperature adds additional cost and components, and is therefore undesirable.

Alternatively, MEMS micromirrors can be fabricated from surface-micromachined polysilicon. In conventional surface-micromachining processes, alternate structural layers of polycrystalline silicon (polysilicon) and sacrificial spacer layers of silicon dioxide (oxide) glass are deposited on bulk silicon or silicon-on-insulator (SOI) wafers. The alternating polysilicon and oxide layer pairs deposited on the substrate may be isolated with a thin layer of silicon nitride. The layers are patterned using photolithographic processes and selectively etched to form freestanding microstructures such as a micromirror. Cuts can be made through the oxide layers and plugged or filled with polysilicon to anchor the upper structural layers to underlying structural layers or to the substrate. After the buildup process, the sacrificial oxide layers are removed using various techniques such as hydrofluoric acid release etching, which frees the device and allows the mirror to move relative to the substrate.

Polysilicon layers may be deposited on the substrate and then polished chemically or mechanically to create smooth polysilicon mirrors. Alternatively, oxide layers may be planarized to create smooth surfaces for a polysilicon mirror. When relatively thick mirrors are constructed from multiple depositions, the polysilicon laminate can warp due to stress differences that exist between the various structural layers. Coating the polysilicon mirror with a reflector will alter and perhaps reduce the radius of curvature, yet a thick polysilicon mirror is still only moderately flat and like the relatively thick single-crystal silicon counterpart, is a heavy, solid structure that is difficult to actuate quickly and efficiently. Thinner and more lightweight polysilicon mirrors, while capable of reliably providing a smoother reflecting surface, are not robust enough to meet the reliability requirements of many optical device applications. Current manufacturing processes for a polycrystalline silicon micromirror do not provide consistent control of stress and stress gradients.

Methods for mitigating mirror curvature have been suggested. For example, Koester proposes that a layer of preferably platinum disposed between a second polysilicon layer and the reflective mirror layer produces high stresses that can counteract the stressed of the first and second doped polysilicon layers, as described in “Polysilicon Microelectronic Reflectors and Beams and Methods of Fabricating Same,” U.S. Patent Application 2002/0186444 published Dec. 12, 2002.

Ion implantation has been used to introduce a compressive stress that helps cancel out some of the existing tensile stress in the mirrors. For example, Aksyuk et al. suggests using a dopant within the light reflective optical layer to increase the tensile stress of a micromirror structure, thereby correcting a concave mirror curvature, as disclosed in “Micro-Electro-Optical Mechanical Device Having an Implanted Dopant Included Therein and a Method of Manufacture Therefor,” U.S. Pat. No. 6,522,801 granted Feb. 18, 2003.

These techniques rely on stress balancing that induces a controllable, countervailing stress in the mirror to cancel an uncontrolled or undesired stress. Stress balancing presumes that the magnitude of the mirror curvature is well understood, measurable, and for practical purposes, consistent. In addition, it presumes that the countervailing stress applied to correct the undesired curvature is also consistent, well understood, and controllable. The underlying assumptions can make these concepts difficult to implement in a manufacturing process.

Another material used for fabricating MEMS micromirrors is silicon nitride. Silicon nitride mirrors with rib elements have been constructed using a combination of bulk and surface micromachining, as described in “Large Area Molded Silicon Nitride Micro Mirrors,” Lutzenberger et al., IEEE Photonics Technology Letters, Vol. 15, No. 10, October 2003, p. 1407-1409. The silicon-nitride mirror with molded silicon nitride fins on the backside of the mirror provides a stiffer and flatter optical surface than many other micromirrors, yet the silicon-nitride mirror still has an insufficiently flat mirrored surface for many beam-steering applications and it is incompatible with many actuator systems built from structural layers. The silicon-nitride mirrors also may be susceptible to charge-trapping and electrostatic drift.

In light of the forgoing discussion of single-crystal silicon, polysilicon, and silicon-nitride mirrors, what is needed is an improved, flatter and more stable low-mass micromirror for a MEMS optical device that minimizes optical loss and optical loss variability typically associated with the micromirror designs of current art. Thus, an improved micromirror design and associated manufacturing processes would substantially eliminate mirror curvature due to internal stresses and stresses from CTE mismatches among deposited mirror materials and from dimensional variations within the mirror structure. The improved micromirror would be lightweight and structurally stable, allowing for faster switching and scanning speeds; would be compatible with electrostatic actuator systems; and would avoid charge trapping, electrostatic drift and warping of the optical surface of the micromirror. Ideally, the manufacture of improved micromirrors eliminates non-standard or complicated processing steps that increase production costs and reduce yield.

### SUMMARY OF THE INVENTION

A first aspect in accordance with the present invention is a micromirror for directing a beam of light. The micromirror includes a mirror plate movably coupled to a substrate with a lower reinforcement rib connected to a lower surface of the mirror plate. The mirror plate has a reflective upper surface. The lower reinforcement rib is formed in a rib trench within the substrate when at least a portion of the mirror plate is formed. The lower reinforcement rib reinforces the mirror plate to minimize mirror plate curvature.

Another aspect in accordance with the present invention is a system for directing a beam of light, including a plurality of micromirrors movably coupled to a substrate. Each micromirror includes a polysilicon mirror plate with a reflective upper surface and a lower reinforcement rib connected to a lower surface of each mirror plate. The lower reinforcement rib is formed in a rib trench within the substrate when at least a portion of the mirror plate is formed, and reinforces the mirror plate to minimize mirror plate curvature.

Another aspect in accordance with the present invention is a method for fabricating a reinforced micromirror. A rib trench is etched into a surface of a substrate. A first sacrificial layer is deposited in the rib trench and on the surface of the substrate. A first structural layer is deposited on the sacrificial layer. The first structural layer is etched to form a mirror plate. The sacrificial layer is removed to separate the mirror plate and the lower reinforcement rib from the substrate. The separated lower reinforcement rib reinforces the mirror plate to minimize mirror plate curvature.

### BRIEF DESCRIPTION OF THE DRAWINGS

The aforementioned, and other features and advantages of the invention will become further apparent from the following detailed description of the presently preferred embodiments, read in conjunction with the accompanying drawings. The detailed description and drawings are merely illustrative of the invention rather than limiting, the scope of the invention being defined by the appended claims and equivalents thereof. Various embodiments of the present invention are illustrated by the accompanying figures, the figures not necessarily drawn to scale, wherein:

FIG. 1 illustrates a micromirror for directing a beam of light, in accordance with one embodiment of the current invention;

FIG. 2 illustrates a top view of a mirror plate with a reinforcement ring connected to a lower surface of the mirror plate, in accordance with one embodiment of the current invention;

FIG. 3 illustrates a cutaway perspective view of a mirror plate with a reinforcement ring, in accordance with one embodiment of the current invention;

FIG. 4 illustrates a top view of a mirror plate with a plurality of reinforcement cells and a reinforcement ring, in accordance with one embodiment of the current invention;

FIG. 5 illustrates a top view of a mirror plate with a plurality of reinforcement cells extending underneath an optical surface of the mirror plate, in accordance with one embodiment of the current invention;

FIG. 6 illustrates a top view of a mirror plate with a plurality of reinforcement rings and radial members, in accordance with one embodiment of the current invention;

FIG. 7 illustrates a cross-sectional view of a mirror plate with the lower reinforcement rib formed in a trench with an angled sidewall, in accordance with one embodiment of the current invention;

FIG. 8 illustrates a cross-sectional view of a reinforced mirror plate with a plurality of filled vias between a first structural layer and a second structural layer, in accordance with one embodiment of the current invention;

FIG. 9 illustrates a cross-sectional view of a reinforced mirror plate with two structural layers and a lower reinforcement rib, in accordance with one embodiment of the current invention.

FIG. 10 illustrates a cross-section view of a mirror plate with a lower reinforcement rib and an upper reinforcement rib, in accordance with one embodiment of the current invention;

FIG. 11 illustrates a system for directing a beam of light, in accordance with one embodiment of the current invention; and

FIG. 12 is a flow chart of a method for fabricating a reinforced micromirror, in accordance with one embodiment of the current invention.

### DETAILED DESCRIPTION OF THE INVENTION

The present invention relates generally to optical switches and scanners, and more specifically to reinforcement structures for thin-film MEMS mirrors. The following description is presented to enable one of ordinary skill in the art to make and use the invention and is provided in the context of a patent application and its requirements. Thus, the present invention is not intended to be limited to the embodiment shown, but is to be accorded the widest scope consistent with the principles and features described herein.

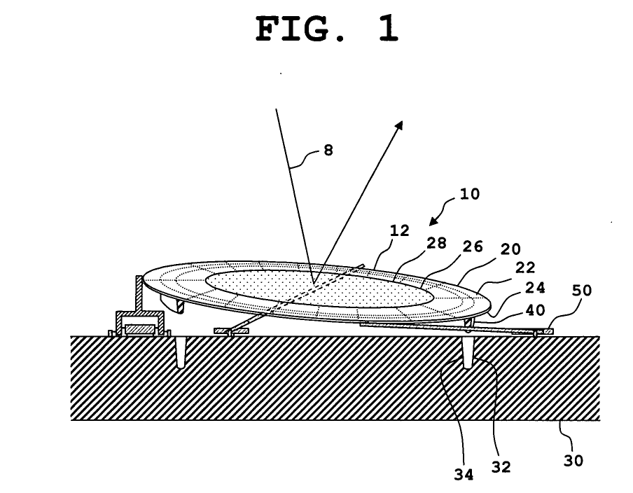

FIG. 1 is an illustrative, partial perspective and partial cross-sectional view of a micromirror 10 for directing a beam of light, in accordance with one embodiment of the present invention. Micromirror 10 may be used, for example, in an optical switch, an optical scanner, or in other applications where directing or redirecting a beam of light is needed. Micromirror 10 may be attached to or formed on a substrate 30 such as a silicon wafer or a portion thereof using a standard or a custom micro-electro-mechanical system (MEMS) process. To minimize mirror plate curvature, a lower reinforcement rib 40 is connected to a lower surface 24 of a mirror plate 20.

Tethers, hinges, torsional springs and other compliant mechanical elements may be used to movably couple mirror plate 20 to substrate 30. To actuate and control the height and orientation angles of mirror plate 20 with respect to the substrate, one or more actuators such as a vertical comb drive electrostatic actuator 50 are coupled between mirror plate 20 and substrate 30. Vertical comb drive electrostatic actuators or other actuators based on, for example, electrostatic, magnetic, electromagnetic or thermal drive mechanisms may be used to control the height of one or more locations on the periphery of mirror plate 20, allowing mirror plate 20 to be moved into a desired orientation.

Mirror plate 20 has a smooth, reflective upper surface 22. To provide greater reflectance of micromirror 10 over a wide range of wavelengths, a mirror reflector 28 such as an alloy of aluminum, copper and silicon or other suitable mirror metal may be disposed on upper surface 22 of mirror plate 20. A portion of upper surface 22, referred to as an optical surface 26, reflects an incident beam of light 8 towards the desired direction. Optical surface 26 of micromirror 10 may include all or a portion of upper surface 22 of mirror plate 20. For example, optical surface 26 may be delineated by the coverage of mirror plate 20 by mirror reflector 28. To enhance smoothness and minimize step height differences on upper surface 22, mirror plate 20 may be planarized.

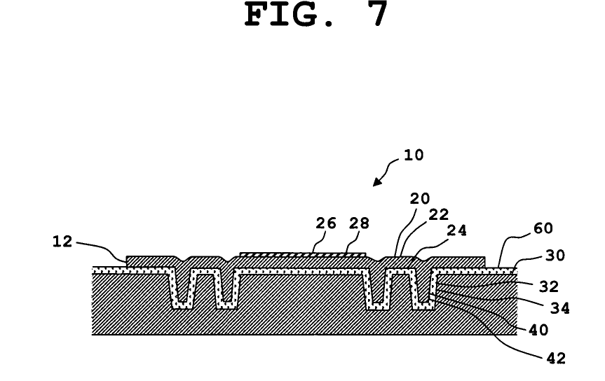

In one example, mirror plate 20 is formed from a first structural layer 12 such as polysilicon or amorphous silicon deposited onto substrate 30 and into rib trench 32. Lower reinforcement rib 40 is formed from the first structural layer 12 as first structural layer 12 is deposited to form at least a portion of mirror plate 20. Lower reinforcement rib 40 and substrate 30 are separated by removing a first sacrificial material (not shown), which is disposed between lower reinforcement rib 40 and rib trench 32 when lower reinforcement rib 40 is formed, as described further with respect to FIG. 7.

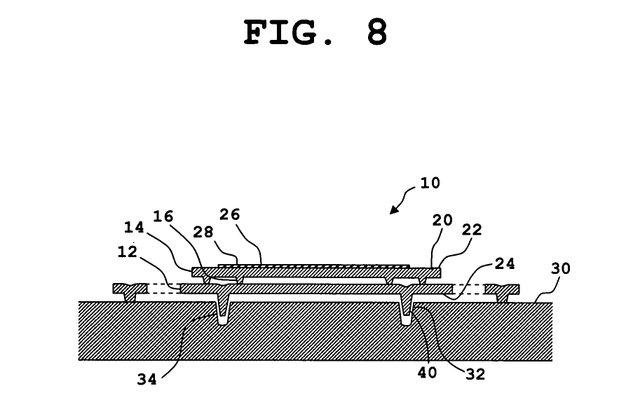

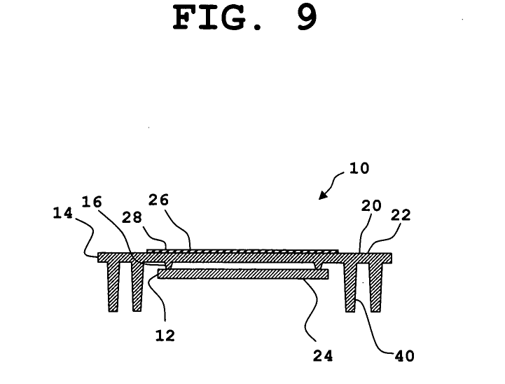

In another example, mirror plate 20 includes a first structural layer 12 and a second structural layer 14 connected to first structural layer 12 with at least one plugged or filled via 16, described further with respect to FIG. 8 and FIG. 9.

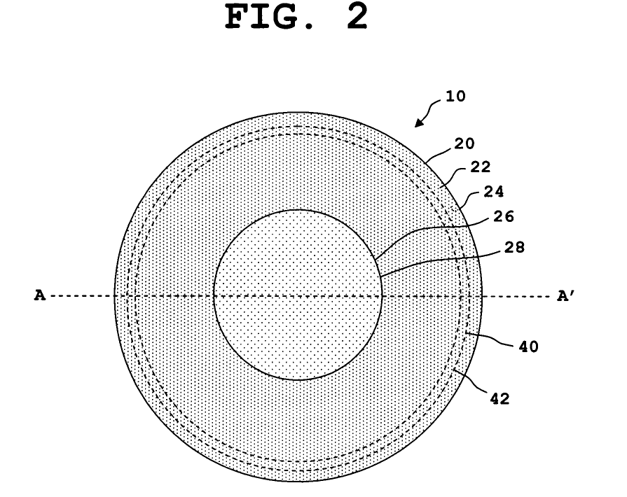

To minimize mirror plate curvature of mirror plate 20, lower reinforcement rib 40 is connected to or formed concurrently with mirror plate 20. Lower reinforcement rib 40 is connected to a lower surface 24 of mirror plate 20 and reinforces mirror plate 20 thereby minimizing mirror plate curvature. Lower reinforcement rib 40 includes, for example, a plurality of reinforcement rings 42, hexagonal cells 44, or radial members 46, as described further with respect to FIG. 2 through FIG. 6. In one example, lower reinforcement rib 40 is peripheral to optical surface 26 of mirror plate 20. In another example, lower reinforcement rib 40 is located under optical surface 26 of mirror plate 20. In another example, lower reinforcement rib 40 is located under and peripheral to optical surface 26. In yet another example, lower reinforcement rib 40 includes at least one reinforcement ring 42 near the periphery of mirror plate 20.

Lower reinforcement rib 40 is formed, for example, in a rib trench 32 within substrate 30 when at least a portion of mirror plate 20 is formed. Rib trench 32 may be formed in substrate 30 by patterning and etching substrate 30, for example, with deep-reactive ion etching. Rib trench 32 within substrate 30 may have angled or vertical sidewalls 34. Vertical sidewalls 34 allow deeper rib trenches 32 resulting in thicker lower reinforcement rib 40. Angled sidewalls 34 allow increased movement of mirror plate 20 as it is positioned above substrate 30.

In another example, lower reinforcement rib 40 is filled when lower reinforcement rib 40 is formed in rib trench 32. That is, as first structural layer 12 for mirror plate 20 is deposited, rib trench 32 fills up and is pinched, and voids or gaps between vertical segments of lower reinforcement rib 40 largely or completely disappear. Alternatively, u-shaped features may be formed as part of lower reinforcement rib 40 when first structural layer 12 is deposited into a wide rib trench 32 having a flat bottom. V-shaped features may be formed as part of lower reinforcement rib 40 when rib trench 32 has angled sidewalls 34 and a pointed bottom.

In another embodiment, described with respect to FIG. 9, micromirror 10 may include an upper reinforcement rib 70 of plated nickel or other suitable material disposed on upper surface 22 of mirror plate 20 alone or in addition to lower reinforcement rib 40 to further minimize mirror plate curvature. Upper reinforcement rib 70 cooperates with lower reinforcement rib 40 to reinforce mirror plate 20.

FIG. 2 illustrates a top view of a mirror plate with a reinforcement ring connected to a lower surface of the mirror plate, in accordance with one embodiment of the present invention. Reinforcement ring 42 of lower reinforcement rib 40 is connected to lower surface 24 of mirror plate 20 to stiffen mirror plate 20 and reduce mirror plate curvature. Alternatively, a series of concentric reinforcement rings 42 may be positioned near the periphery of mirror plate 20. Optical surface 26 of mirror plate 20 may be coated with a mirror reflector 28 on upper surface 22 to increase reflectivity of micromirror 10.

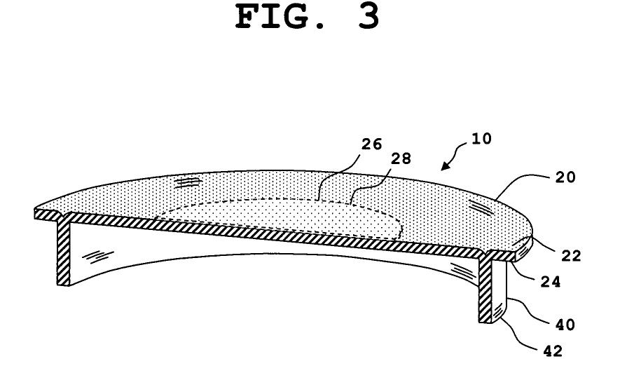

FIG. 3 illustrates a cutaway perspective view of a mirror plate with a reinforcement ring, in accordance with one embodiment of the present invention. Taken along line A-A′ of FIG. 2, mirror plate 20 of micromirror 10 includes an upper surface 22 and a lower surface 24. Attached to lower surface 24 of mirror plate 20 is a lower reinforcement rib 40. In the example shown, a single reinforcement ring 42 is located near the periphery of mirror plate 20 to provide reinforcement. Lower reinforcement rib 40 is formed when mirror plate 20 is formed, such as from a deposited film of polycrystalline silicon or amorphous silicon. A mirror reflector 28 may be disposed on upper surface 22 of mirror plate 20 to serve as an optical surface 26.

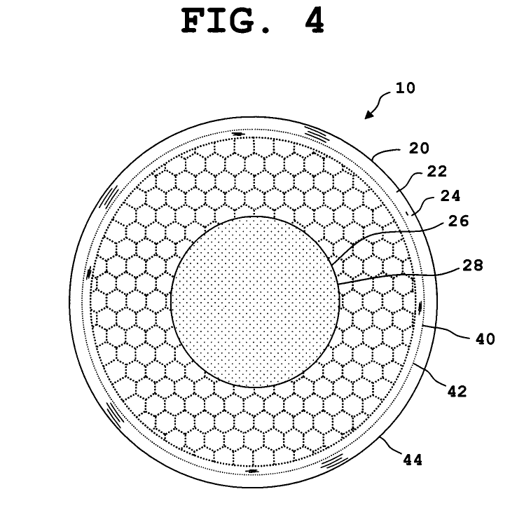

FIG. 4 illustrates a top view of a mirror plate with a plurality of reinforcement cells and a reinforcement ring, in accordance with one embodiment of the present invention. A mirror plate 20 of a micromirror 10 includes an upper surface 22 and a lower surface 24. A lower reinforcement rib 40 is connected to lower surface 24 of mirror plate 20. Lower reinforcement rib 40 includes a reinforcement ring 42 and an array of hexagonal cells 44 near the periphery of mirror plate 20. Hexagonal cells 44 and reinforcement ring 42 are located peripherally to an optical surface 26 of mirror plate 20. Hexagonal cells 44 and reinforcement ring 42 provide additional stiffness for mirror plate 20, distribute stress, and minimize mirror plate curvature. A mirror reflector 28 may be disposed on upper surface 22 of mirror plate 20 to serve as an optical surface 26. In another embodiment, lower reinforcement rib 40 includes an array of hexagonal cells 44 connected to lower surface 24 of mirror plate 20 without reinforcement ring 42.

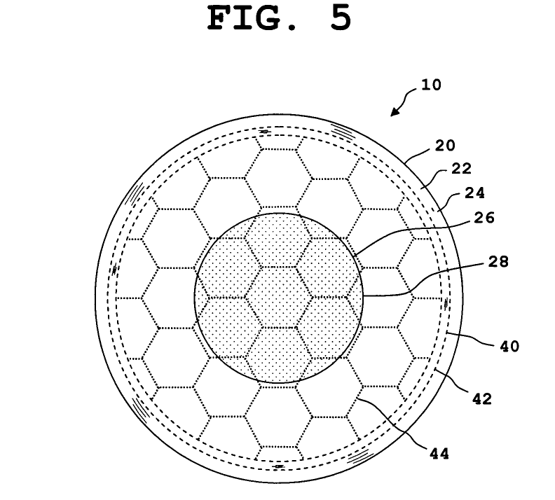

FIG. 5 illustrates a top view of a mirror plate with a plurality of reinforcement cells extending underneath an optical surface of the mirror plate, in accordance with one embodiment of the present invention. A micromirror 10 includes an optical surface 26 on an upper surface 22 of a mirror plate 20, with an optional mirror reflector 28 on optical surface 26. A lower reinforcement rib 40 is connected to a lower surface 24 of mirror plate 20. Lower reinforcement rib 40 stiffens mirror plate 20 and minimizes mirror plate curvature. Lower reinforcement rib 40 includes an array of hexagonal cells 44 and a reinforcement ring 42 located near the periphery of mirror plate 20. Lower reinforcement rib 40 is located peripheral to optical surface 26 of mirror plate 20, and is also located under optical surface 26 of mirror plate 20. To avoid topological variations of optical surface 26 when lower reinforcement rib 40 is formed underneath mirror plate 20, mirror plate 20 may be planarized. In another example, hexagonal cells 44 are formed under mirror plate 20 without reinforcement ring 42 on the periphery of mirror plate 20. Hexagonal cells 44 may extend towards the periphery of mirror plate 20, terminating at or near the outer edge of mirror plate 20.

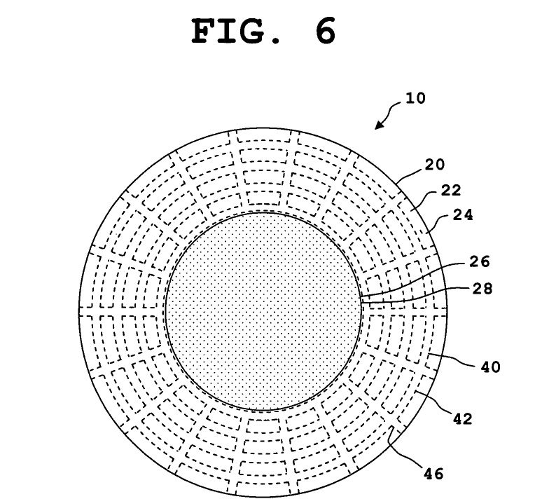

FIG. 6 illustrates a top view of a mirror plate with a plurality of reinforcement rings and spoked or radial members, in accordance with one embodiment of the present invention. A mirror plate 20 of a micromirror 10 includes an upper surface 22, a lower surface 24, and an optical surface 26 that may include a mirror reflector 28. A lower reinforcement rib 40 is connected to lower surface 24 of mirror plate 20. Lower reinforcement rib 40 includes a plurality of reinforcement rings concentrically configured, with an array of radial members 46 connected between reinforcement rings 42 to provide mechanical support for mirror plate 20. Lower reinforcement rib 40, including reinforcement rings 42 and radial members 46, are peripheral to optical surface 26 of mirror plate 20. Additional reinforcement rings 42 and extended radial members 46 may be located under optical surface 26 of mirror plate 20.

FIG. 7 illustrates a cross-sectional view of a mirror plate with the lower reinforcement rib formed in a trench having an angled sidewall, in accordance with one embodiment of the present invention. A micromirror 10 includes a mirror plate 20 with a lower reinforcement rib 40. Lower reinforcement rib 40 is formed in a rib trench 32 within a substrate 30, rib trench 32 having vertical or angled sidewalls 34. Lower reinforcement rib 40 is formed when mirror plate 20 is formed, that is, when a first structural layer 12 is deposited on first sacrificial layer 60. Depending on the width of rib trench 32, lower reinforcement rib 40 may be filled when lower reinforcement rib 40 is formed in rib trench 32. As the deposited material grows thicker on the surface of substrate 30 with first sacrificial layer 60, rib trench 32 is filled with material and the material deposited on sidewalls 34 grow together to fill rib trench 32. First structural layer 12 may be planarized to remove dimples, detents, and other shifts in step height of mirror plate 20, particularly on portions of optical surface 26 of mirror plate 20 that are above rib trench 32.

The depth and width of rib trench 32 determine in part the thickness and height of lower reinforcement rib 40. A first sacrificial layer 60 such as a deposited oxide or a thermally grown silicon dioxide is disposed between lower reinforcement rib 40 and rib trench 32 when lower reinforcement rib 40 is formed. First sacrificial layer 60 is subsequently removed with, for example, an etchant that removes sacrificial oxide yet does not etch substrate 30 or structural layers that comprise mirror plate 20. Two reinforcement rings 42 are illustrated, though other reinforcement structures such as hexagonal cells or radial elements may also be incorporated. A mirror reflector 28 may be deposited, patterned and etched on an upper surface 22 of mirror plate 20 to increase the reflectivity of an optical surface 26 of mirror plate 20.

When first sacrificial layer 60 is removed, lower reinforcement rib 40 and lower surface 24 of mirror plate 20 are separated from substrate 30 and mirror plate 20 may be actuated with, for example, a vertical comb drive electrostatic actuator 50 formed on substrate 30, not shown here for clarity.

FIG. 8 illustrates a cross-sectional view of a reinforced mirror plate with a plurality of filled vias between a first structural layer and a second structural layer, in accordance with one embodiment of the present invention. Mirror plate 20 includes a first structural layer 12 and a second structural layer 14. Second structural layer 14 is connected to first structural layer 12 with at least one filled via 16. An array of filled vias 16 filled with structural material can be positioned between first structural layer 12 and second structural layer 14 to increase the effective thickness of mirror plate 20. To avoid an air gap and detents in optical surface 26, a single, large filled via 16 can be used to laminate second structural layer 14 directly on top of first structural layer 12. A lower reinforcement rib 40 connected to lower surface 24 of mirror plate 20 stiffens and supports mirror plate 20. Lower reinforcement rib 40 is formed in a rib trench 32 with vertical or angled sidewalls 34, and then released from substrate 30 with removal of a sacrificial layer (not shown) between lower reinforcement rib 40 and rib trench 32. A mirror reflector 28 may be deposited on an upper surface 22 of second structural layer 14 to improve the reflectivity of micromirror 10.

When released, mirror plate 20 is coupled to substrate 30 with one or more tethers, hinges, flexures or torsional springs and one or more actuators to allow micromirror 10 to be moved and positioned.

FIG. 9 illustrates a cross-sectional view of a reinforced mirror plate 20 with two structural layers and a lower reinforcement rib, in accordance with one embodiment of the present invention. Lower reinforcement rib 40 is created from second structural layer 14, with filled vias 16 connecting second structural layer 14 to a portion of first structural layer 12 underneath optical surface 26. Lower reinforcement rib 40 is connected to lower surface 24 of mirror plate 20 through one or more filled vias 16. A mirror reflector 28 may be deposited on an upper surface 22 of second structural layer 14 to improve the reflectivity of micromirror 10.

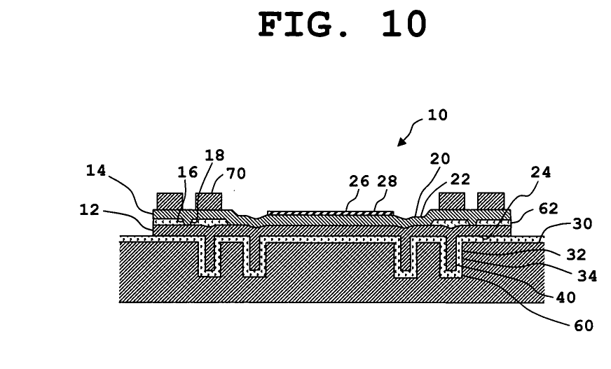

FIG. 10 illustrates a cross-section view of a mirror plate with a lower reinforcement rib and an upper reinforcement rib, in accordance with one embodiment of the present invention. A mirror plate 20 of a micromirror 10 includes a first structural layer 12 and a second structural layer 14, which are connected together with at least one filled via 16 to effectively thicken mirror plate 20 in a central region while maintaining a smooth optical surface 26. A mirror reflector 28 may be positioned on an upper surface 22 of mirror plate 20 at optical surface 26.

A first sacrificial layer 60, which is disposed on a substrate 30 and in a rib trench 32, separates first structural layer 12 from substrate 30 and sidewalls 34 of rib trench 32. A second sacrificial layer 62 separates second structural layer 14 from first structural layer 12, except where via holes 18 are etched in second sacrificial layer 62. In places where via holes 18 are etched, second structural layer 14 contacts first structural layer 12. For example, many via holes 18 are etched and filled with material from second structural layer 14 to form filled vias 16 and allow separation between second structural layer 14 and first structural layer 12. In the area of optical surface 26, a relatively large via hole is formed, allowing second structural layer 14 to directly contact first structural layer 12 in the vicinity of optical surface 26. When first sacrificial layer 60 and second sacrificial layer 62 are removed, lower surface 24 of mirror plate 20 is separated from substrate 30, and mirror plate 20 may be moved with respect to substrate 30.

Lower reinforcement rib 40 is formed in rib trench 32 within substrate 30 when first structural layer 12 is deposited. An upper reinforcement rib 70, such as one or more rings, hexagonal cells, radial members or combinations thereof, may be formed on an upper surface 22 of mirror plate 20 to further stiffen and reduce mirror plate curvature. For example, electroless or electroplating of nickel, copper, or other metal or metal alloy may form upper reinforcement rib 70 on upper surface 22.

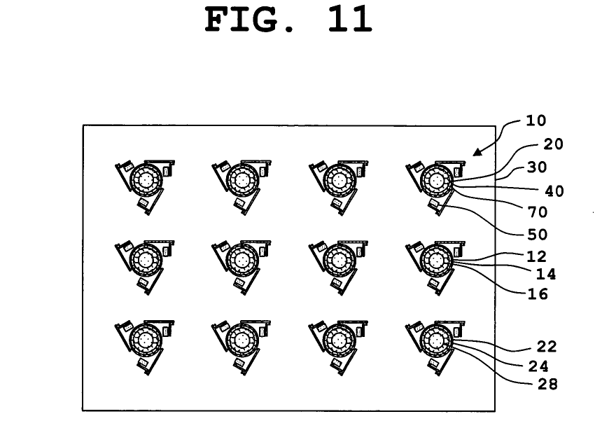

FIG. 11 illustrates a system for directing a beam of light, in accordance with one embodiment of the present invention. The exemplary system includes a plurality of micromirrors 10 movably coupled to a substrate 30. Each micromirror 10 includes a mirror plate 20 with a reflective upper surface 22 and a lower surface 24. Each mirror plate 20 is coupled to substrate 30 with at least one vertical comb drive electrostatic actuator 50 or other suitable actuator, and each mirror plate 20 has a lower reinforcement rib 40 connected to lower surface 24 of mirror plate 20. Lower reinforcement rib 40 is formed in a rib trench 32 (not shown here for clarity) within substrate 30 when at least a portion of mirror plate 20 is formed. Lower reinforcement rib 40 reinforces mirror plate 20 to minimize mirror plate curvature.

In one example, each mirror plate 20 includes a first structural layer 12. In another example, each mirror plate 20 includes a first structural layer 12 and a second structural layer 14 connected to first structural layer 12 with at least one filled via 16.

A mirror reflector 28 may be disposed on upper surface 22 of each mirror plate 20. An upper reinforcement rib 70 may be disposed on upper surface 22 of each mirror plate 20.

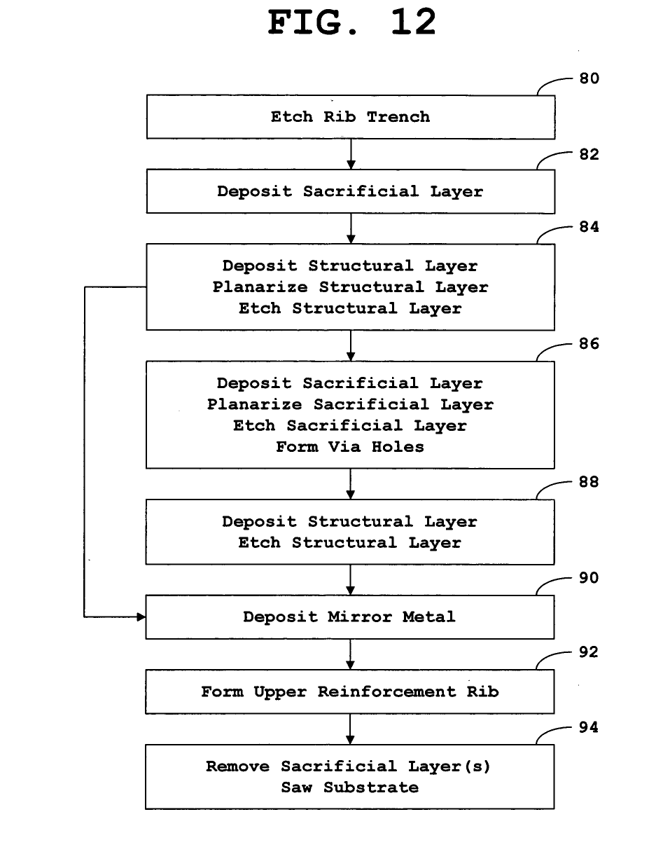

FIG. 12 is a flow chart of a method for fabricating a reinforced micromirror, in accordance with one embodiment of the present invention. The method includes various steps to form or fabricate a reinforced micromirror. The steps may be added prior to or after other fabrication steps such as process sequences for co-fabricating integrated circuitry, and may be intermingled with other steps such as process steps for co-fabricating actuators.

A rib trench is etched into a surface of a substrate such as a silicon wafer, as seen at block 80. After patterning with, for example, a photomask and a photosensitive polymer referred to as photoresist, the rib trench is etched into the substrate using a deep reactive ion etch (D-RIE) or other suitable trench-etch process. The etched rib trench may have angled or vertical sidewalls and a pointed or relatively flat bottom. The width of the rib trench near the surface of the substrate may be selected, for example, to allow subsequently deposited structural layers to fill the rib trench. Alternatively, the rib trench etch may be used to form v-shaped or u-shaped features in the lower reinforcement rib. Rib trenches may be, for example, between five and fifty microns (micrometers) or more deep.

A first sacrificial layer is deposited into the rib trench and on the surface of the substrate, as seen at block 82. The first sacrificial layer may include a deposited oxide such as low-pressure chemical-vapor deposited (LPCVD) oxide, low-temperature oxide (LTO), plasma-enhanced chemical-vapor deposited (PECVD) oxide, or a thermal oxide grown by injecting oxygen in the form of gas or steam into a furnace with the wafer at an elevated temperature. The thickness of the first sacrificial layer and subsequently deposited second sacrificial layer may be, for example, between 0.1 microns and eight microns or more. The first sacrificial layer may be patterned and etched at select locations to form windows so that subsequent structural layers may be anchored to the substrate.

A first structural layer is deposited on the sacrificial layer, as seen at block 84. The first structural layer is deposited on the substrate and in the rib trench to form the lower reinforcement rib. The structural layer may include a layer of polysilicon, an amorphous, hydrogenated silicon layer, or a layer of other suitable structural material. The thickness of each of the structural layers may be, for example, between 0.5 microns and 2.5 microns. The first structural layer may be planarized after deposition, which rids the surface of topological differentialities such as dimples and steps on the surface of the first structural layer. The first structural layer is etched to form at least a portion of a mirror plate, using photoresist and a suitable photomask. Processing may be then be continued with deposition and patterning of a mirror metal, as seen at block 90. Alternatively, a second structural layer may be added, as described with respect to block 86.

A second sacrificial layer such as deposited oxide, thermal oxide, or a spin-on glass (SOG) may be deposited on the first structural layer, as seen at block 86. The second sacrificial layer may be patterned and etched to form via holes and other features. The deposited second sacrificial layer may be planarized prior to depositing the second structural layer. The second sacrificial layer is patterned and etched to form at least one via hole in the second sacrificial layer. The via holes may expose portions of the underlying first structural layer, the substrate, and any other included layers. Via holes may be used, for example, to connect the second structural layer to the first structural layer with a gap in between the two structural layers. In one example, an array of small via holes is formed in localized areas peripheral to the optical surface of the mirror plate. In another example, a via hole may be made suitably large such that the second structural layer is in direct contact with the first structural layer underneath the entire optical surface of the mirror plate.

A second structural layer such as polysilicon or amorphous silicon is deposited on the second sacrificial layer and exposed portions of underlying layers, as seen at block 88. The second structural layer is connected to the first structural layer with at least one filled via formed in via holes etched in the second sacrificial layer. The second structural layer is then patterned and etched to form the mirror plate and other features, using photoresist, a photomask and a suitable etchant. The mirror plate may have a diameter, for example, between 50 microns and 3000 microns. Planarizing of the second structural layer may include polishing the deposited second structural layer prior to patterning and etching, or may include polishing the second sacrificial layer prior to depositing the second structural layer. The second structural layer may be planarized in addition to or in lieu of planarization of the second sacrificial layer.

To improve the reflectivity of the micromirror, a mirror metal may be deposited on an upper surface of the mirror plate, as seen at block 90. The deposited mirror metal includes, for example, an alloy of aluminum, copper and silicon, or other suitable mirror metal such as gold or platinum.

Prior to releasing the micromirrors, an upper reinforcement rib of nickel or other suitable metal may be plated on the upper surface of the mirror plate, as seen at block 92. The upper reinforcement rib may include one or more concentric reinforcement rings, an array of hexagonal cells, one or more radial members, or a combination thereof. The upper reinforcement rib cooperates with the lower reinforcement rib to reinforce the mirror plate and minimize mirror curvature.

The first sacrificial layer is removed to separate the mirror plate and the lower reinforcement rib from the substrate, as seen at block 94. The separated lower reinforcement rib reinforces the mirror plate to minimize mirror plate curvature. In cases where a second sacrificial layer and a second structural layer are included in the formation of the micromirror, the second sacrificial layer is also removed when the first sacrificial layer is removed. The sacrificial etchant, such as diluted or buffered hydrofluoric acid, removes the sacrificial layer down to the substrate and over time removes all of the sacrificial material between the first structural layer, the second structural layer, and the substrate. The substrate may be sawed or otherwise diced prior to sacrificial etching or after sacrificial etching as desired.

In another embodiment, lower reinforcement ribs are formed from the second structural layer when the second structural layer is deposited into the rib trench. Filled vias connect the second structural layer to a portion of the first structural layer formed underneath the optical surface of the mirror plate. To achieve this, a first sacrificial oxide is deposited followed by deposition of a first structural layer with associated patterning and etching. The rib trench is then patterned and etched, followed by deposition of a second sacrificial oxide and a second structural layer with associated patterning and etching to form the mirror plate.

In another embodiment, a reflective dielectric stack is deposited on the mirror plate in lieu of a mirror metal to form the mirror reflector. While the embodiments of the invention disclosed herein are presently considered to be preferred, various changes and modifications can be made without departing from the spirit and scope of the invention. For example, the process steps for fabrication may be made in an alternate order, or the dimensions and thickness of the trenches, structural layers, sacrificial layers, patterned features may be different from what is indicated, as one skilled in the art would recognize. An additional layer of polysilicon may be added, for example, underneath the structural layers to form a ground plane. Other layers such as sacrificial, structural, or dielectric layers may be added, patterned and etched. For example, a third or a fourth structural layer may be added and structurally combined with the other structural layers to form the mirror plate. As such, the designations of first and second in the context of structural and sacrificial layers have been defined herein as a matter of convenience and clarity, and do not imply the order in which various layers are deposited, particularly when a more extensive process is used. The scope of the invention is indicated in the appended claims, and all changes that come within the meaning and range of equivalents are intended to be embraced therein.

1. A micromirror for directing a beam of light, the micromirror comprising:
a mirror plate movably coupled to a substrate, the mirror plate having a reflective upper surface; and
a lower reinforcement rib coupled to a lower surface of the mirror plate, wherein the lower reinforcement rib is formed in a rib trench within the substrate when at least a portion of the mirror plate is formed, and wherein the lower reinforcement rib reinforces the mirror plate to minimize mirror plate curvature.

2. The micromirror of claim 1, wherein the mirror plate is coupled to the substrate with at least one vertical comb drive electrostatic actuator.

3. The micromirror of claim 1, wherein the substrate comprises a portion of a silicon wafer.

4. The micromirror of claim 1, wherein the rib trench within the substrate has one of an angled sidewall or a vertical sidewall.

5. The micromirror of claim 1, wherein the lower reinforcement rib is filled when the lower reinforcement rib is formed in the rib trench.

6. The micromirror of claim 1, wherein the lower reinforcement rib and the substrate are separated by removing a first sacrificial material disposed between the lower reinforcement rib and the rib trench when the lower reinforcement rib is formed.

7. The micromirror of claim 1, wherein the lower reinforcement rib is peripheral to an optical surface of the mirror plate.

8. The micromirror of claim 1, wherein the lower reinforcement rib is located under an optical surface of the mirror plate.

9. The micromirror of claim 1, wherein the lower reinforcement rib comprises at least one reinforcement ring near the periphery of the mirror plate.

10. The micromirror of claim 1, wherein the lower reinforcement rib comprises a plurality of reinforcement rings, hexagonal cells, or radial members.

11. The micromirror of claim 1, wherein the mirror plate is planarized.

12. The micromirror of claim 1, wherein the mirror plate comprises a first structural layer and a second structural layer, the second structural layer coupled to the first structural with at least one filled via.

13. The micromirror of claim 1 further comprising:
a mirror metal disposed on the upper surface of the mirror plate.

14. The micromirror of claim 13, wherein the mirror metal comprises an alloy of aluminum, copper and silicon.

15. The micromirror of claim 1 further comprising:
an upper reinforcement rib disposed on the upper surface of the mirror plate, wherein the upper reinforcement rib cooperates with the lower reinforcement rib to reinforce the mirror plate.

16. A system for directing a beam of light, the system comprising:
a plurality of micromirrors movably coupled to a substrate,
wherein each micromirror includes a mirror plate having a reflective upper surface and a lower reinforcement rib coupled to a lower surface of each mirror plate, and
wherein the lower reinforcement rib is formed in a rib trench within the substrate when at least a portion of the mirror plate is formed, and
wherein the lower reinforcement rib reinforces the mirror plate to minimize mirror plate curvature.

17. The system of claim 16, wherein each mirror plate is coupled to the substrate with at least one vertical comb drive electrostatic actuator.

18. The system of claim 16, wherein each mirror plate comprises a first structural layer and a second structural layer, the second structural layer coupled to the first structural layer with at least one filled via.

19. The system of claim 16 further comprising:
a mirror metal disposed on the upper surface of each mirror plate.

20. The system of claim 16 further comprising:
an upper reinforcement rib disposed on the upper surface of each mirror plate.

21. A method of fabricating a reinforced micromirror, the method comprising:
etching a rib trench into a surface of a substrate;
depositing a first sacrificial layer in the rib trench and on the surface of the substrate;
depositing a first structural layer on the first sacrificial layer;
etching the first structural layer to form at least a portion of a mirror plate; and
removing the first sacrificial layer to separate the mirror plate and the lower reinforcement rib from the substrate, wherein the separated lower reinforcement rib reinforces the mirror plate to minimize mirror plate curvature.

22. The method of claim 21 wherein the etched rib trench comprises one of an angled sidewall or a vertical sidewall.

23. The method of claim 21 wherein the first sacrificial layer comprises one of a deposited oxide or a thermal oxide.

24. The method of claim 21 further comprising:
planarizing the first structural layer after depositing the first structural layer.

25. The method of claim 21 further comprising:
depositing a second sacrificial layer on the first structural layer;
etching the second sacrificial layer to form at least one via hole in the second sacrificial layer;
depositing a second structural layer on the second sacrificial layer;
etching the second structural layer to form the mirror plate; and
removing the second sacrificial layer, wherein the second structural layer is coupled to the first structural layer with at least one filled via.

26. The method of claim 25 further comprising:
planarizing the deposited second sacrificial layer prior to depositing the second structural layer.

27. The method of claim 21 further comprising:
depositing a mirror metal on an upper surface of the mirror plate.

28. The method of claim 27 wherein the deposited mirror metal comprises an alloy of aluminum, copper and silicon.

29. The method of claim 21 further comprising:
plating an upper reinforcement rib on the upper surface of the mirror plate, wherein the upper reinforcement rib cooperates with the lower reinforcement rib to reinforce the mirror plate.
